(19) United States
(12) Patent Application Publication
(10) Pub. No.: US 2008/0268120 A1
(43) Pub. Date: Oct. 30, 2008

(54) Method for the Production of Frozen Bars With Variations in Section

(75) Inventors: Michel Flambeau, Strasbourg (FR); Yves Gerber, Strasbourg (FR); Alain Picquet, Wasselonne (FR)

Correspondence Address: FITZPATRICK CELLA HARPER & SCINTO, 30 ROCKEFELLER PLAZA, NEW YORK, NY, 10112, US

(73) Assignee: MARS INCORPORATED, McLean, VA (US)

(21) Appl. No.: 11/914,527

(22) PCT Filed: May 18, 2006
(86) PCT No.: PCT/EP2006/004740

§ 371 Date: Jun. 30, 2008

(30) Foreign Application Priority Data
May 18, 2005 (FR) 05 04 999

(51) Int. Cl. A23P 1/12

(52) U.S. Cl. 426/516; 99/485

(57) ABSTRACT

The method allows the production of a food bar with an extrusion nozzle (2). The food product is extruded through the nozzle above a flat support such as a conveyor (1) so that the extruded product (4) is deposited onto it. During extrusion, a relative movement (I a, 6) between the nozzle and the flat support is created obtaining overall a relative rectilinear travel (Ia) between the nozzle and the flat support in order to form the bar of product. Moreover, the quantity of extruded product deposited on the flat support per unit of length in the direction of travel is varied. This variation can be obtained by defining the relative nozzle/support movement in an appropriate way, for example by a reciprocating movement (6) of the nozzle relative to the conveyor (1).

The present invention relates to the production of food bars, in particular frozen food bars.

In the field of frozen confectionery, it is known to produce bars with a constant section throughout their length. A traditional apparatus for producing them comprises a horizontal extrusion nozzle arranged fixed just above a horizontal conveyor belt. The frozen product is extruded through the nozzle and is deposited on the conveyor belt which travels in the direction of extrusion of the product. The speed of travel of the conveyor belt and the speed of extrusion of the frozen product are constant. A continuous bar of frozen product—also commonly called a strip—is thus formed on the conveyor belt, the bar having a constant section throughout its length. Downstream of the extrusion nozzle, the conveyor belt passes into a cooling tunnel in which the temperature of the product is reduced in order to solidify it. Outside the cooling tunnel, a knife at regular intervals cuts the continuous bar into bars of the desired length which are then, if appropriate after coating, packaged in their wrappers.

It is also known to produce frozen food products such as ice cream or sorbet using the molding technique, which allows the production of products of a given length optionally having raised shapes.

It is now sought to provide frozen bars in the form of a series of a succession of balls or spheres attached to one another while having a flat common base.

More generally, there is a need to provide food bars, in particular frozen bars, with raised patterns on the top, or also on their lateral sides while having a flat base.

The natural solution which occurs to a person skilled in the art to produce such frozen bars would be to mould them.

However molding has the drawback of being a rather slow and relatively costly method.

But apart from molding there is no satisfactory technique for producing such bars. The other known techniques aim to produce products in the form of braids, twists, flatbreads as described for example in U.S. Pat. No. 4,536,147, U.S. Pat. No. 5,391,073, EP-A-0 044 689, EP-A-0 223 884, EP-A-0 328 170 and WO 99/41995 or also bars with very irregular and random reliefs as in EP-A-1 356 743.

The aim of the present invention is therefore to provide a technology which allows the production of food bars, in particular frozen bars, having raised patterns on the top, or also on their lateral sides while preferably having a flat base. The invention is also aimed at allowing the raised pattern to be regular and repetitive, for example in the form of balls attached to one another.

To this end, the present invention provides a method for the production of a bar of food product with an extrusion nozzle, comprising the stages of:

extrusion of the product through the nozzle above a flat support so that the extruded product is deposited on the flat support; and

during extrusion, relative movement between the nozzle and the flat support, the movement obtaining overall a relative rectilinear travel between the nozzle and the flat support in order to form the bar of product; and

during extrusion, variation of the quantity of extruded product deposited on the flat support per unit of length in the direction of travel.

According to preferred embodiments, the method comprises one or more of the following characteristics:
during the stage of extrusion, obtaining a variation in the quantity of extruded product deposited on the flat support per unit of length in the direction of travel, by the relative movement between the nozzle and the flat support;
during the stage of extrusion, maintaining the axis of the nozzle in the same vertical plane associated with the flat support and parallel to the relative rectilinear direction of travel between the nozzle and the flat support;
during the stage of extrusion, applying a unidirectional rectilinear movement at a constant speed to the flat support during extrusion; and applying to the nozzle a movement with a reciprocating component according to the direction of movement of the flat support;
during the stage of extrusion, ensuring that the average value of the component of the vector speed of movement of the nozzle according to the direction of movement of the flat support, during the movement of the nozzle in the direction of movement of the flat support, is greater than the speed of movement of the flat support;
during the stage of extrusion, ensuring that the speed of extrusion of the product is greater than or equal to the speed of movement of the flat support;
during the stage of extrusion, either keeping the axis of the nozzle parallel to itself during the movement of the nozzle, the nozzle only moving according to one direction parallel to the flat support, or maintaining the axis of the nozzle parallel to itself during the movement of the nozzle, the movement of the nozzle including at least one component parallel to the flat support and at least one component perpendicular to the flat support, or swinging the nozzle about an axis which is both parallel to the flat support and perpendicular to the direction of travel of the flat support;
during the stage of extrusion, moving the nozzle in a repetitive manner along the same path with the same speed pattern;
during the stage of extrusion, keeping the angle between the axis of the nozzle and the flat support between −5 and +45 degrees, the nozzle being oriented in the direction of travel of the flat support;
the application, in a continuous manner, of the unidirectional rectilinear movement at a constant speed of the flat support during the extrusion; and cutting the bar of product up into discontinuous elements;
providing the flat support in the form of an endless conveyor belt;
the horizontal arrangement of the flat support;
during the stage of extrusion, maintaining the speed of extrusion of the product constant;
the food product comprises at least one frozen composition, the method comprising a stage of cooling the bar formed on the flat support;
providing the nozzle with lateral cheeks projecting outwards relative to the outlet of the nozzle;
the nozzle has two superimposed outlets having a common wall set back relative to the end contour of the nozzle, the method comprising the extrusion of a respective food composition through each of the outlets of the nozzle;
also including a stage of coating of the bar;

According to another aspect, the invention also provides a device implementing the method of the invention. In particular it provides a device for the production of a bar of food product, comprising:
an endless conveyor belt; and
a nozzle for extrusion of the product situated above the conveyor belt so that the extruded product is deposited on the conveyor belt;

in which:
the conveyor belt is driven by a unidirectional rectilinear movement at a constant speed during extrusion; and
the nozzle is driven by a movement with a reciprocating component according to the direction of movement of the conveyor belt.

The device can also comprise a cooling tunnel into which the conveyor belt passes.

According to yet another aspect, the invention relates to a bar of food product obtained by the method according to the invention.

Other characteristics and advantages of the invention will become apparent when reading the following description of preferred embodiments of the invention, given as non-limitative examples and with reference to the attached drawing.

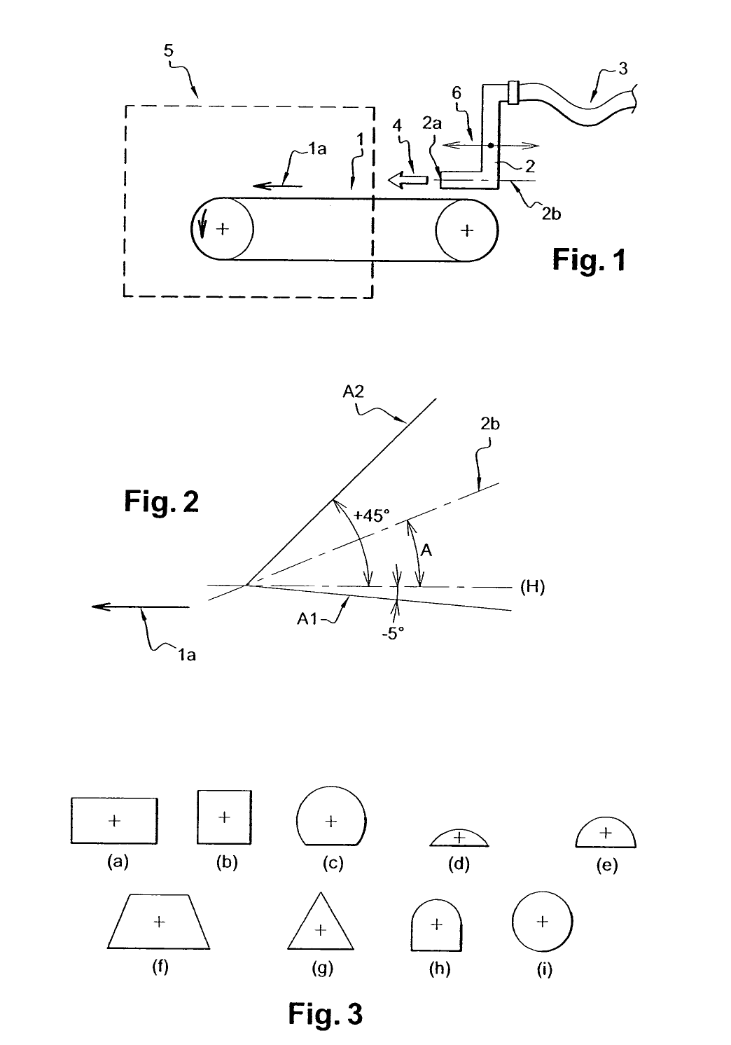

FIG. 1 represents a diagram of an installation for extrusion of ice cream.

FIG. 2 illustrates the angular positioning of the axis of the nozzle for the installation of FIG. 1.

FIG. 3 schematically represents possible different sections of the extrusion nozzle.

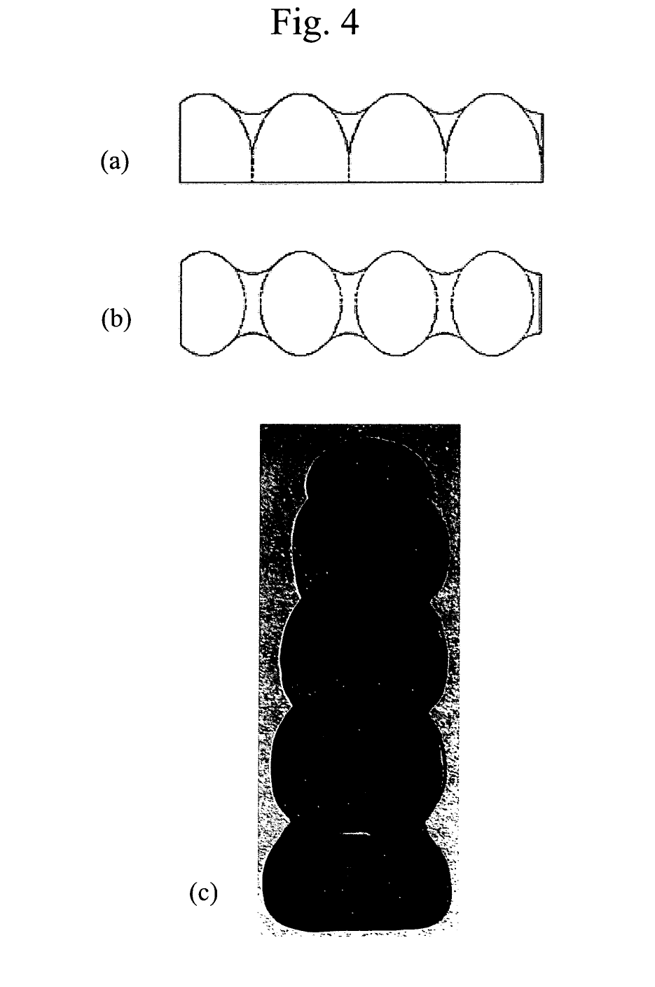

FIGS. 4 (a) and (b) are schematic representations of respectively a side view and a top view of an example of a frozen bar which is obtained and FIG. 4 (c) a photograph of the frozen bar which is obtained coated in chocolate.

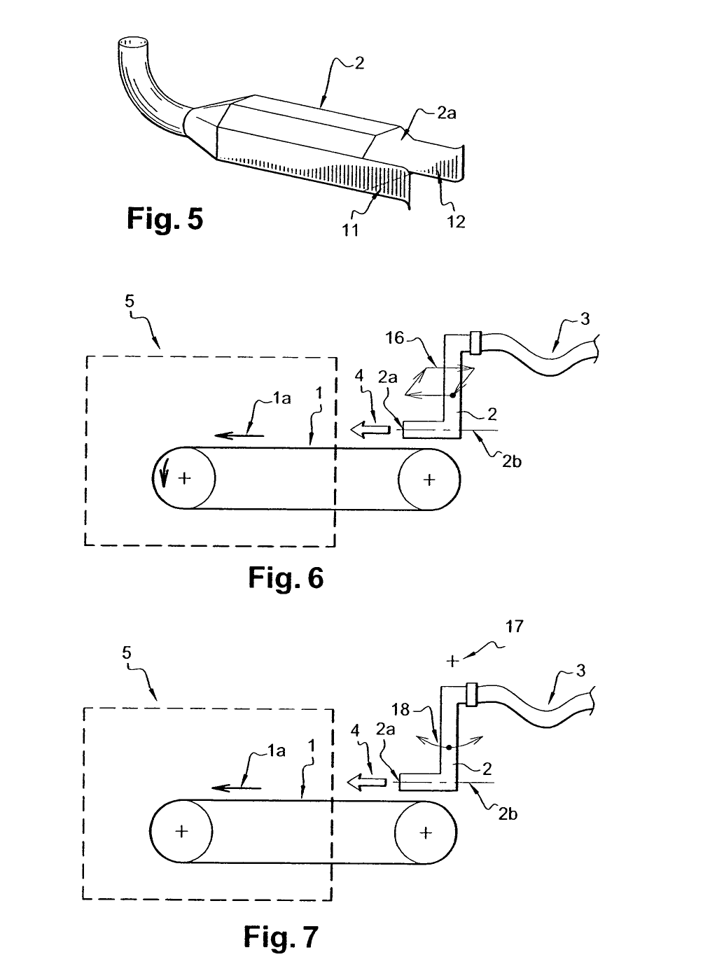

FIG. 5 is a perspective schematic view of an extrusion nozzle having lateral cheeks.

FIGS. 6 and 7 each represent another embodiment relative to that of FIG. 1.

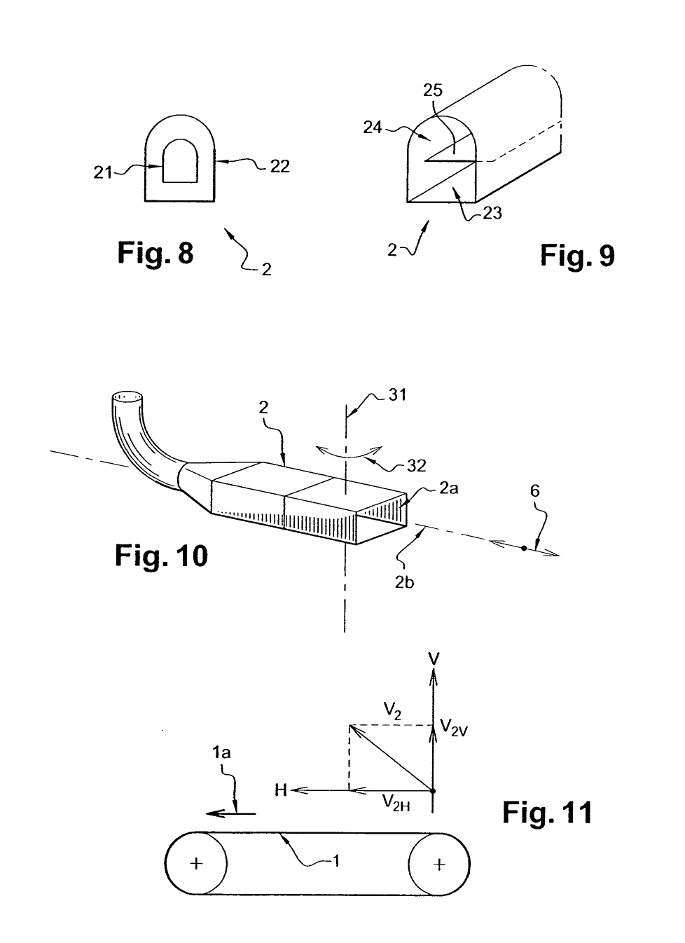

FIG. 8 illustrates the section of a twin nozzle for coextrusion.

FIG. 9 is a perspective diagram of the end of a coextrusion nozzle having two superimposed outlets.

FIG. 10 illustrates the possibility of obtaining a lateral swinging movement of the nozzle.

FIG. 11 shows the break-down of the vector speed of movement of the nozzle into two perpendicular components.

According to the invention, extrusion of the food product through a nozzle is once again used. The food product is extruded through the nozzle above a flat support so that the extruded product is deposited on the flat support.

During the extrusion, a relative movement between the nozzle and the flat support is ensured. The relative movement is defined in order to produce, overall, a relative rectilinear travel between the nozzle and the flat support. By means of this travel, the extruded product deposited on the flat support forms a bar of product.

Moreover, during the extrusion, a variation in the quantity of extruded product deposited on the flat support per unit of length in the direction of travel is ensured. Consequently, a variation in section is obtained along the bar formed.

It is advantageous to choose the relative movement between the nozzle and the flat support in order to obtain not only the travel mentioned above, but also a variation in the quantity of extruded product which is deposited on the flat support per unit of length in the direction of travel. In this case, the speed of extrusion of the product at the outlet of the nozzle can be constant.

FIG. 1 illustrates a particularly simple installation which can implement a preferred embodiment of the invention in order to produce frozen bars from a frozen composition such as ice cream. It comprises an extrusion nozzle 2 and a conveyor 1 in the form of an endless belt 1 which serves as a flat support for receiving the extruded food product. The arrow 4 symbolizes the extruded food product.

The conveyor belt 1 is preferably horizontal: The end 2a by which the extruded product leaves the nozzle 2 is placed above the conveyor belt 1. Thus, the extruded product is deposited by gravity on the conveyor belt 1.

The axis 2b of the nozzle 2 is horizontal and parallel to the direction of travel of the conveyor belt 1. The end 2a of the nozzle is oriented in the direction of travel of the conveyor belt 1.

The nozzle 2 is mounted mobile in translation in the direction of travel of the conveyor belt 1. In other words, the end 2a of the nozzle 2 is capable of moving forward and back relative to the conveyor 1. In order to make this movement possible, the nozzle 2 is supplied with food product by a fixed pumping device or similar—not shown—by means of a flexible pipe 3. As a variant, the flexible pipe 3 is replaced with rigid telescopic tubes. According to another variant, the pipe 3 is replaced with a bellows system.

When the food product is extruded in order to produce the frozen bar, the conveyor belt 1 travels continuously at a constant speed and the food product is extruded at a constant speed at the outlet 2a of the nozzle 2. By contrast, the nozzle 2 is driven by a reciprocating movement from the front to the back relative to the conveyor 1, the end 2a of the nozzle always remaining above the conveyor belt. This reciprocating movement is symbolized by the double arrow 6. In this embodiment, the axis 2b of the nozzle 2 always remains horizontal and contained in the same vertical plane parallel to the direction of travel of the conveyor belt 1 during the extrusion operation. In this case, this vertical plane is one with the plane of the sheet of diagram 1. The reciprocating movement of the nozzle 2 is obtained for example with a linear motor or with a rotary motor with a cam system or also with a pneumatic cylinder.

Considered in the reference frame associated with the end 2a of nozzle 2, the reciprocating movement of nozzle 2 results in a modulation of the speed of travel of the conveyor belt 1. Consequently, the quantity of product deposited by the nozzle 2 on the conveyor belt 1 per unit of length in the direction of travel of the conveyor belt 1 varies. A bar or strip having a variable section along its length is then obtained.

In the most simple embodiment, the reciprocating movement of the nozzle 2 always has the same distance of travel and the same speed pattern. The section of the resulting bar varies in this case according to an identical pattern which is repeated throughout its length.

In order to allow its extrusion, the temperature of the food product is chosen so that it is not entirely solid while being sufficiently viscous to ensure that the bar of product formed on the conveyor belt retains its shape. In the case of frozen compositions, the formulation is taken into account, which also influences the stability of the shape after extrusion. Downstream of the nozzle 2, the conveyor belt 1 passes into a cooling tunnel 5 in which the temperature of the product is reduced in order to solidify the bar of food product. Outside the cooling tunnel, in a standard manner, a knife can be provided which, at regular intervals, cuts the continuous bar into bars of the desired length. The thus cut bars can optionally be coated, for example with chocolate, which is also solidified by cooling in another tunnel. Finally, the bars are packaged in their wrappers.

It is advantageous that the nozzle 2 is arranged at a small distance above the conveyor belt 1, for example between 1 and 15 mm, which prevents the extruded product from tending to be crushed as a result of the drop onto the conveyor belt 1 under the effect of its own weight which would have the effect of a reduction in the variations in section in terms of height of the resulting bar. For the same reason, it is preferable that the axis 2b of the nozzle 2 is horizontal as mentioned previously or is at a fixed angle to the conveyor belt 1 comprised between −5 and 45 degrees, the outlet 2a of the nozzle 2 being oriented in the direction of travel of the conveyor belt 1. This angular interval is illustrated by FIG. 2 in which (H) represents a horizontal plane, the segments A1 and A2 the extreme angles between which the axis 2b is preferably situated forming an angle A with the horizontal line and the arrow 1a indicates the direction of travel of the conveyor belt 1. As described previously, the reciprocating movement of the nozzle 2 occurs—in this embodiment—according to a horizontal direction parallel to the direction of travel of the conveyor belt 1 as described previously, even if the axis of the nozzle is not chosen to be horizontal.

By way of illustration, the food product can be an ice cream comprising 8 to 16% by weight of fat, 34 to 45% by weight of solid matter, the rest being water. In a standard manner it comprises an emulsifier for example fatty acid mono- and diglycerides and a stabilizer such as alginates or guar. Its “overrun”—i.e. the volume of air added to the liquid mixture relative to the volume of the latter—is comprised between 50 and 140%. The appropriate extrusion temperature is comprised between −4.5 and −6° C.

The frozen composition, in particular ice cream, can also comprise solid inclusions, for example chocolate chips or pieces of biscuit, nuts such as walnuts, almonds, peanuts, hazelnuts or centres thickened for example with wheat-, corn- or rice flour. These inclusions are then introduced into the frozen composition upstream of the nozzle 2.

The shape of the nozzle 2 is chosen as a function of the section of the bar to be obtained. The nozzle 2 can advantageously have a flat lower part, which allows the product to be extruded with a flat base. The resulting bar thus has a flat base allowing the consumer to place it down in a stable manner. But a bar with a flat base can also be obtained with a nozzle 2 which does not have a flat base under the effect of the weight of the product. By way of examples illustrated by FIG. 3, the section of the nozzle 2 can be in the shape of a rectangle (a), a square (b), a circle cut by a bowstring (c), a flattened oval (d), a semi-circle (e), a trapezoid (f), a triangle (g), semi-oblong in section (h) or in the shape of a circle (i).

This type of nozzle makes it possible to obtain a resulting bar with a flat base, the section of which varies both in height and in width along the bar. The surface of the section of the nozzle 2 is chosen as a function of the section dimensions to be obtained for the frozen bar.

The speed of travel of the conveyor belt 1, the speed of extrusion at the outlet of the nozzle 2 and the movement speed pattern of the nozzle 2 as well as its distance of travel—which may optionally be varied—are appropriately chosen as a function of the desired variations in section of the resulting bar. The speed of extrusion is preferably chosen slightly greater than the speed of travel of the conveyor belt 1, for example equal to 1.1 to 1.4 times the speed of travel.

By way of example, the speed of extrusion is 1.2 times the speed of travel of the conveyor belt 1. The distance of travel of the nozzle 2 is 22 mm. The average speed of forward movement of the nozzle 2 is 1.8 times the speed of travel and the speed of backward movement of the nozzle 2 is 4 times the speed of travel. The speed of travel is preferably comprised between 3 and 7 m/min. With these parameters and a nozzle of the type shown in FIG. 3 (c), a frozen bar is obtained which is shown in a side view and in a top view in FIGS. 4 (a) and (b). FIG. 4 (c) represents a photograph of the bar obtained coated in chocolate, taken from a point above the bar.

Numerous variants exist. Thus, if the section of the bar obtained is sought not to vary on the sides, but only on the top, it is sufficient to arrange lateral cheeks at the end 2a of the nozzle 2, these cheeks extending beyond the outlet of the nozzle 2 in the direction of travel of the conveyor belt 1. One example of a nozzle with lateral cheeks 11, 12 is illustrated by FIG. 5. The free end of each of the lateral cheeks is preferably curved outwards, i.e. on the side opposite the other cheek. Thus, during the reciprocating movement of the nozzle 2, the lateral cheeks maintain the smoothness of the lateral sides of the resulting bar. Consequently, the bar has a constant section widthwise.

Moreover, it can be provided to use a coextrusion. In particular, it is possible to coextrude two different frozen compositions one inside the other. For this, it is sufficient to use a twin nozzle 2 having a nozzle 21 inside another nozzle 22 as illustrated in FIG. 8. Such a twin nozzle 2 also allows a sauce or a syrup, in particular caramel, to be coextruded inside a frozen composition. As a variant, it is possible to coextrude two different frozen compositions one on top of the other. For this, it is sufficient to use a coextrusion nozzle 2 having one outlet 23 superimposed on another outlet 24 as illustrated in FIG. 9. In this case, it is advantageous that the common wall 25 of the two outlets is set back relative to the outer perimeter of the end 2a of the nozzle 2. This measure ensures that the two extruded compositions adhere to one another.

In a further developed embodiment illustrated by FIG. 6, it is provided that the nozzle 2 can not only move forwards and backwards, but also upwards relative to the conveyor belt 1. The operation is identical to the installation of FIG. 1, except as regards the movement of the nozzle 2. In this case, the nozzle 2 always moves in the same vertical plane comprising its axis combining a horizontal movement and a vertical movement. For example, the movement of the nozzle 2 can follow a path in a parallelogram, in particular a rectangle, in repetitive manner. In other words, the nozzle 2 moves forward, then rises, then moves back, then falls, and so on, relative to the conveyor 1 and the direction of travel of its belt. The horizontal and vertical movements of the nozzle 2 can be successive or simultaneous. The axis 2b always remains parallel to itself during the cycle of movement of the nozzle 2. The cycle of movement of the nozzle 2 in terms of distance and speed pattern can advantageously be repeated identically, thus the section of the resulting bar varies according to an identical pattern which is repeated throughout its length. This possibility is illustrated by the four arrows forming the parallelogram 16 and which represent the movements of the nozzle 2. The combination of the horizontal movement and the vertical movement allows different bar shapes to be obtained compared with the installation of FIG. 1.

In another embodiment schematically illustrated by FIG. 7, the nozzle 2 is mounted in rotation about an axis 17 horizontal and perpendicular to the direction of travel of the conveyor belt 1. The operation is identical to the installation of FIG. 1, except as regards the movement of the nozzle 2. In this case, the nozzle 2 is driven by a swinging movement forward/backward relative to the conveyor 1. The swinging movement is indicated in FIG. 7 by the double arrow 18. The axis 2b of the nozzle 2 always remains situated in the same vertical plane parallel to the direction of travel of the conveyor belt 1. Once again, the swinging movement allows different bar shapes to be obtained compared with the installation of FIG. 1.

For all of the embodiments combining a movement of the nozzle 2 with a conveyor belt 1 travelling at constant speed, it is preferable to ensure that the average value of the component of the vector speed of movement of the nozzle 2 according to the direction of travel of the conveyor belt 1, during movement of the nozzle according to the direction of travel of the conveyor belt 1, is greater than the speed of travel of the conveyor belt. FIG. 11 shows the instantaneous speed vector V₂ of the nozzle 2 at a given moment during its movement forwards in the direction of travel of the horizontal conveyor belt 1. FIG. 11 shows its horizontal component V_{2H} obtained by projection of the vector V₂ on a straight line (H) parallel to the direction of travel of the conveyor belt 1 and its vertical component V_{2V} obtained by projection of the vector V₂ on a straight line (V) perpendicular to the conveyor belt 1. This measure obtains the formation of a mass of extruded product on the conveyor belt 1 when the nozzle 2 moves forwards compared to the case of the prior art having a fixed nozzle 2 and a constant speed of travel of the conveyor belt 1. This results in a local increase in the section of the bar. By contrast, the backwards movement of the nozzle 2 produces a local decrease in the section of the bar compared to the case of the prior art having a fixed nozzle 2 and a constant speed of travel of the conveyor belt 1. It is also preferable that the speed of extrusion of the product is at least equal to and more advantageously greater than the speed of travel of the conveyor belt 1, which allows the shape of the extruded product to be preserved.

In yet another embodiment, the nozzle 2 is mounted fixed. In this case, the speed of travel of the conveyor belt 1 is not kept constant, but is modulated around an average value. This allows the same relative movement to be obtained as in the case of the installation of FIG. 1. In yet another embodiment, the conveyor 1 is replaced by a fixed flat support. In this case, the nozzle 2 travels in a straight line above the flat support. The speed of travel of the nozzle 2 is modulated in order to obtain the same effect as in the case of the installation of FIG. 1. A vertical movement of the nozzle 2 or a swinging movement in a vertical plane can also be provided, in a similar way to the embodiments described previously. Nevertheless, embodiments with a conveyor 1 having a belt travelling at constant speed are preferred because of the ease of use and the resulting compactness.

For all of the embodiments mentioned above and as illustrated in FIG. 10, there may also be provided an additional movement of the nozzle 2 relative to an axis 31 which is both perpendicular to the axis 2b of the nozzle 2 and comprised in a vertical plane comprising the direction of travel of the conveyor belt 1. In FIG. 10, only the nozzle 2 is shown, in a perspective view. The arrow 6 indicates the reciprocating movement of the embodiment of FIG. 1. The axis 31 is fixed relative to the nozzle 2 during its horizontal reciprocating movement or other movement described in relation to FIG. 6 or 7. Thus, during extrusion, the nozzle 2 is driven by a swinging movement about the axis 31 which is combined with the horizontal reciprocating movement 6 or with the movement previously described in relation to FIG. 6 or 7. This swinging movement is explained symbolically by the double arrow 32. This measure allows a zigzag or slight snaking effect to be obtained in the lengthwise direction of the bar obtained which, overall, remains rectilinear. The movement of the nozzle 2 preferably occurs in a symmetrical manner relative to a vertical plane parallel to the direction of travel of the conveyor belt 1.

As a variant, a lateral translational reciprocating movement of the nozzle 2 can be envisaged which combines with the horizontal forward/backward reciprocating movement 6 or those described previously in relation to FIGS. 5 and 6. In other words, the nozzle 2 also describes a reciprocating movement according to a horizontal direction perpendicular to the direction of travel of the conveyor belt 1. Once again, this measure allows a zigzag or snaking effect to be obtained in the lengthwise direction of the bar obtained which, overall, remains rectilinear.

According to another embodiment, the speed of extrusion at the outlet of the nozzle 2 is varied. This measure allows the quantity of extruded product deposited on the flat support per unit of length in the direction of travel to be varied. In this case it can be provided that the nozzle 2 is fixed relative to the conveyor 1 and that the conveyor belt travels at a constant speed. Advantageously, the variation in speed consists of a repetitive extrusion speed pattern in order to obtain for the bar a repetitive raised pattern. It is also possible to combine the variation in the speed of extrusion with the previous embodiments based on the variation of the quantity of extruded product deposited on the conveyor belt 1 per unit of length in the direction of travel by means of the relative movement between the nozzle and the conveyor belt.

According to yet another embodiment, the conveyor 1 is replaced with a long, fixed table above which the nozzle 2 moves in order to provide overall a rectilinear travel of the nozzle relative to the table. Thus, a bar or strip of extruded product is formed on the table. The variation in the quantity of extruded product deposited on the flat support per unit of length in the direction of travel is provided once again either by the movement of the nozzle relative to the table, or by the variation in the speed of extrusion, or by a combination of the two. Nevertheless the use of an endless conveyor belt 1 is simpler to implement.

Of course, the present invention is not limited to the examples and the embodiments described and illustrated, but it is capable of many variants accessible to a person skilled in the art. Thus, the embodiments of the invention were described for the production of frozen bars which usually have a maximum section which does not exceed 1000 mm², but it can also be used in order to produce bars with a larger section exceeding for example 2500 mm², or even 6000 mm², in particular frozen logs. The invention and each of the embodiments described can also be used in the field of non-frozen bars, for example in the field of food for animals, in particular for pets, in particular for the production of “snacks” for the latter. It is worth noting that the obtained bar is a plain food product. In particular, the bar is not made of overlapping extruded lanes of products. On the contrary, the bar itself is extruded and the variable section of the bar is advantageously obtained by forming masses of extruded products resulting in a local increase in the section of the bar, each mass being followed by a local decrease in the section of the bar.

1. A method for producing an extruded bar of food product with an extrusion nozzle, comprising the stage of:
extruding the product through the nozzle above a flat support so that the extruded product is deposited on the flat support; and
during the extrusion, applying a relative movement between the nozzle and the flat support so that the relative movement produces overall a relative rectilinear travel between the nozzle and the flat support in order to form the bar of product; and
during the extrusion, varying the quantity of extruded product deposited on the flat support per unit of length in a direction defined by the relative rectilinear travel so as to provide the bar with a variable section along its length.

2. The method according to claim 1 which, during the stage of extrusion, comprises varying the quantity of extruded product deposited on the flat support per unit of length in the direction of travel, by the relative movement between the nozzle and the flat support.

3. The method according to claim 1, wherein the nozzle has an axis, the method further comprising during the stage of extrusion:
keeping the axis of the nozzle in a same vertical plane associated with the flat support and parallel to the direction defined by the relative rectilinear travel between the nozzle and the flat support.

4. The method according to claim 1 which, during the stage of extrusion, comprises:
applying a unidirectional rectilinear movement at a constant speed to the flat support; and
applying to the nozzle a movement having a reciprocating component according to a direction of travel defined by the unidirectional rectilinear movement of the flat support.

5. The method according to claim 4, wherein the movement of the nozzle defines a vector speed for the nozzle, the method further comprising during the stage of extrusion:
ensuring that an average value of a component of the vector speed of the nozzle according to the direction of travel of the flat support, during the movement of the nozzle in the direction of travel of the flat support, is greater than the constant speed of movement of the flat support.

6. The method according to claim 5 which, during the stage of extrusion, comprises:
ensuring that the speed of extrusion of the product is greater than or equal to the constant speed of movement of the flat support.

7. The method according to claim 4 which, during the stage of extrusion, comprises:
keeping the axis of the nozzle parallel to itself during the movement of the nozzle, the nozzle only moving according to one direction parallel to the flat support.

8. The method according to claim 4, wherein the nozzle has an axis, the method further comprising during the stage of extrusion:
keeping the axis of the nozzle parallel to itself during the movement of the nozzle, the movement of the nozzle comprising at least one component parallel to the flat support and at least one component perpendicular to the flat support.

9. The method according to claim 4 which, during the stage of extrusion, comprises:
swinging of the nozzle about an axis both parallel to the flat support and perpendicular to the direction of travel of the flat support.

10. The method according to claim 4 which, during the stage of extrusion, comprises:
applying a repetitive movement to the nozzle along a same path with a same speed pattern.

11. The method according to claim 4, wherein the nozzle has an axis, the method further comprising during the stage of extrusion:
keeping an angle between the axis of the nozzle and the flat support between −5 and +45 degrees, the nozzle being oriented in the direction of travel of the flat support.

12. The method according to claim 4, comprising:
applying, in a continuous manner, the unidirectional rectilinear movement at a constant speed to the flat support during the extrusion; and
cutting the bar of product up into discontinuous elements.

13. (canceled)

14. (canceled)

15. The method according to 4 which, during the stage of extrusion, comprises:
keeping a speed of extrusion of the product constant.

16. The method according to claim 1 to claim 1, in which the food product comprises at least one frozen composition, the method comprising a stage of cooling of the bar formed on the flat support.

17. The method according to claim 1 which comprises providing the nozzle with lateral cheeks projecting outwards relative to the outlet of the nozzle.

18. The method according to claim 1 in which the nozzle comprises two superimposed outlets having a common wall set back relative to an end contour of the nozzle, the method comprising:
extruding a respective food composition through each of the outlets of the nozzle.

19. (canceled)

20. The method according to claim 1, wherein the nozzle is located at a distance above the flat support which is less than or equal to the height of the nozzle.

21. The method according to claim 1 comprising the step of:
during the extrusion, variation in the quantity of extruded product deposited on the flat support per unit of length in the direction of travel so as to provide the bar with a variable section along its length in the form of a repetitive pattern of a mass of extruded product resulting in a local increase in the section of the bar followed by a local decrease in the section of the bar.

22. A device for the production of an extruded bar of food product, comprising:
an endless conveyor belt; and
a nozzle for extrusion of the product situated above the conveyor belt so that the extruded product is deposited on the conveyor belt;
in which the conveyor belt is driven by a unidirectional rectilinear movement at a constant speed during extrusion and the nozzle is driven by a movement with a reciprocating component according to the direction of movement of the conveyor belt so as to provide the bar with a variable section along its length.

23. The device according to claim 22, comprising a cooling tunnel into which the conveyor belt passes.

24. (canceled)

25. A food product bar, obtained by the method according to claim 1.
